(19) United States
(12) Patent Application Publication
(10) Pub. No.: US 2015/0329749 A1
(43) Pub. Date: Nov. 19, 2015

(54) ADHESIVE MIXTURE, ADHESIVE, FILM INCLUDING THE SAME, AND PREPARATION METHOD THEREOF

(71) Applicant: 3M INNOVATIVE PROPERTIES COMPANY, St. Paul, MN (US)

(72) Inventor: Guoliang Zhang, Shanghai (CN)

(21) Appl. No.: 14/652,574

(22) PCT Filed: Dec. 31, 2012
(86) PCT No.: PCT/CN2012/088059

§ 371 Date: Jun. 16, 2015

(51) Int. Cl. C09J 133/08

(52) U.S. Cl. CPC C09J 133/08

(57) ABSTRACT

A pressure sensitive adhesive mixture includes a (meth)acrylate polymer and a weak alkaline metal imide or amine. The weak alkaline metal imide or amine has a pKa of 11 to 20 and the molar ratio of the weak alkaline metal imide or amine to the —COOH groups contained in the (meth)acrylate polymer is in a range of about 1.0 to about 5.0. An adhesive formed from the adhesive mixture, a film including an adhesive layer formed from the adhesive mixture and a preparation method thereof are also provided.

### TECHNICAL FIELD

An adhesive mixture, an adhesive, a film including the same, and a preparation method thereof are provided. Especially the adhesive can be a type of pressure sensitive adhesive.

### BACKGROUND ART

Protective films (PFs) are widely used for screens of touch panels (TPs), liquid crystal display modules (LCMs) and hand mobile manufactures (HMMs) in order to protect the screens from outside damages.

In most (meth)acrylate adhesive based protective films, acid-free (meth)acrylate adhesive is used to form the pressure sensitive adhesive layer of protective films, such as those used for protection of screens. However, a kind of visual defect, a ghosting mark, which cannot be removed by cleaning with organic solvents is observed on the surface of the screens covered with such (meth)acrylate based protective films. This kind of ghosting mark is permanent, which is different from the ghosting marks removable by using organic solvents. Therefore, such (meth)acylate based protective films, although protect the screens from outside damages, may cause an unexpected defect in the screen surface.

There is a need of (meth)acrylate based protective films which can alleviate the possibility of permanent ghosting marks appeared on the screens.

### SUMMARY

An adhesive mixture/composition and a film including the same are provided in this disclosure. The adhesive mixture/composition can be used to prepare the adhesive layer of a film. For example, the adhesive mixture/composition can be used to prepare the adhesive layer of a protective film to be used to protect a screen. Thanks to the adhesive mixture/composition, such protective film can alleviate the possibility of permanent ghosting marks appeared on screens.

In one aspect, the present application provides an adhesive mixture including a (meth)acrylate polymer, and a weak alkaline metal imide or amine. The weak alkaline metal imide or amine has a pKa of 11 to 20. The molar ratio of the weak alkaline metal imide or amine to the —COOH groups contained in the (meth)acrylate polymer is in a range of 1.0-5.0.

In another aspect, the present application provides an adhesive composition prepared from the above pressure sensitive adhesive mixture.

In another aspect, the present application provides a film, including a backing layer and an adhesive layer supported by the backing layer. Alternatively, the backing layer has a first surface and the adhesive layer can be in contact with the first surface of the backing layer. The adhesive layer is formed by an adhesive mixture including a (meth)acrylate polymer and a weak alkaline metal imide or amine, wherein the weak alkaline metal imide or amine has a pKa of 11 to 20 and the molar ratio of the weak alkaline metal imide or amine to the —COOH groups contained in the (meth)acrylate polymer is in a range of 1.0-5.0.

In yet another aspect, the present application provides a method of preparing a film including the steps of (b) adding a weak alkaline metal imide or amine into a (meth)acrylate polymer to obtain a mixture, wherein the weak alkaline metal imide or amine has a pKa of 11 to 20, and the molar ratio of the weak alkaline metal imide or amine to the —COOH groups contained in the (meth)acrylate polymer is in a range of 1.0-5.0; (c) applying the mixture obtained in step (b) on at least part of a backing layer to form an adhesive layer; and (d) drying the backing layer and the adhesive layer. Alternatively, the method further comprises a step of (a) determining the amount of —COOH groups in a (meth)acrylate polymer, commonly before the step (b).

### BRIEF DESCRIPTION OF THE DRAWINGS

FIG. 1 is a microphotograph showing ghosting marks on a polycarbonate (PC) substrate attached with a conventional protective film in a comparative example.

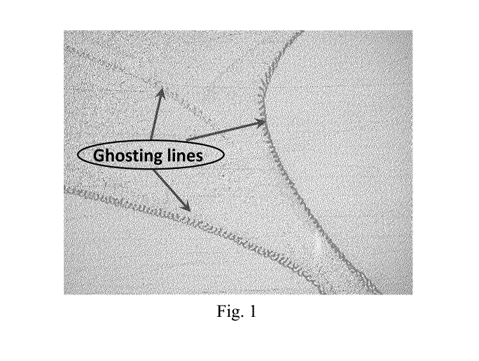

### DETAILED DESCRIPTION

The inventors of the disclosure found that the permanent ghosting marks on screens covered by (meth)acrylate based protective films are acid etched traces caused by —COOH acid groups in the acid-free (meth)acrylate adhesive used to form the pressure sensitive adhesive layer of protective films. Although known as “acid-free (meth)acrylate adhesive”, the adhesive usually contains some small quantity, such as about 0.01-0.1 wt %, of acid groups, based on the total weight of the adhesive. The presence of —COOH acid groups in the adhesive is inevitable and can be attributed to incomplete conversion of carboxyl groups to ester groups.

The surfaces of the screens are made of organic materials, such as polymers including polycarbonate, ABS resins, etc. The acidic groups in the adhesive layer, although present in a trace amount, can etch the surface of the screen and leave permanent ghosting marks, which cannot be removed by wiping with organic solvents. This problem is solved by introducing a weak alkaline metal imide or amine into the adhesive which forms the pressure sensitive adhesive layer of the protective film.

The term “pressure sensitive adhesive” refers to an adhesive that exhibits persistent tack, adhesion to a substrate with no more than finger pressure, and sufficient cohesive strength to be removed cleanly from the substrate.

The term “ghosting” refers to a visually perceptible, blurry imprint at a surface.

The term “(meth)acrylate” refers to (meth)acrylic acid esters, i.e. esters of acrylic acid or methacrylic acid.

The term “alkaline metal imide or amine” refers to a metal imide or amine having alkalinity.

All percentages, concentrations, parts, etc. used herein are based on weight, unless specified otherwise.

In one aspect, the present application provides an adhesive mixture including a (meth)acrylate polymer and a weak alkaline metal imide or amine. Especially, this adhesive mixture can be used to prepare pressure sensitive adhesive of screen protective film with an advantage of alleviating the possibility of permanent ghosting marks appeared on the screens.

The (meth)acrylate polymer may be a homopolymer of a (meth)acrylate monomer or a copolymer of a (meth)acrylate monomer with one or more comonomers. The (meth)acrylate polymer may also be mixtures of one or more (meth)acrylate homopolymers and/or one or more (meth)acrylate copolymers. The (meth)acrylate monomer can be selected from alkyl (meth)acrylates having an alkyl group of 1-20 carbon atoms, aryl (meth)acrylates having an aryl group of 6-12 carbon atoms, and aralkyl (meth)acrylates having an aralkyl group of 6-12 carbon atoms. In some embodiments, the (meth)acrylate monomer can be selected from alkyl (meth)acrylates having an alkyl group of 1-10 carbon atoms so as to maintain a suitable cohesion under high temperature.

Alkyl (meth)acrylates can include at least one linear, branched, or cyclic structure. Non-limiting examples of alkyl (meth)acrylates include: methyl methacrylate, ethyl methacrylate, n-butyl methacrylate, isobutyl methacrylate, tert-butyl methacrylate, neopentyl methacrylate, cyclohexyl methacrylate, isobornyl methacrylate, hexyl methacrylate, octyl methacrylate, isooctyl methacrylate, decyl methacrylate, dodecyl methacrylate, isotridecyl methacrylate, tetradecyl methacrylate, hexadecyl methacrylate, octadecyl methacrylate, eicosyl methacrylate, methyl acrylate, ethyl acrylate, n-butyl acrylate, isobutyl acrylate, tert-butyl acrylate, neopentyl acrylate, cyclohexyl acrylate, isobornyl acrylate, hexyl acrylate, octyl acrylate, isooctyl acrylate, decyl acrylate, dodecyl acrylate, isotridecyl acrylate, tetradecyl acrylate, hexadecyl acrylate, octadecyl acrylate, and eicosyl acrylate. Non-limiting examples of aryl (meth)acrylates include phenyl methacrylate, phenyl acrylate, 4-methylphenyl methacrylate, 4-methylphenyl acrylate, 1-naphthyl methacrylate, 1-naphthyl acrylate, 2-naphthyl methacrylate, and 2-naphthyl acrylate. Non-limiting examples of aralkyl (meth)acrylates include benzyl methacrylate and benzyl acrylate.

Non-limiting examples of comonomers include: vinyl monomers, such as acrylonitrile; (meth)acrylamide; and styrenic monomers, including styrene, α-methylstyrene, 2-methylstyrene, and 4-methylstyrene. The comonomers can be used to adjust the glass transition temperature (Tg) and other physical properties such as, for example, the cohesive strength of the (meth)acrylate polymer. Polar monomers may also be used. Examples of the polar monomers include, but are not limited to: hydroxy alkyl (meth)acrylate, unsubstituted (meth)acrylamide, N-alkyl substituted (meth)acrylamide, N,N-dialkyl substituted (meth)acrylamide, monomer containing urea functionality, monomer containing lactam functionality, tertiary amine, alicyclic amine, aromatic amine, and combinations thereof. Suitable examples of hydroxy alkyl (meth)acrylate include 2-hydroxyethyl (meth)acrylate, 3-hydroxypropyl (meth)acrylate, and combinations thereof. A suitable example of N-alkyl substituted (meth)acrylamide is N-octyl acrylamide. Suitable examples of N,N-dialkyl substituted (meth)acrylamide include N,N-dimethyl acrylamide, N,N-diethylacrylamide, and a combination thereof. Suitable examples of tertiary amine, alicyclic amine, and aromatic amine is selected from the group consisting of vinyl pyridine, vinyl imidazole, and N,N-dialkyl amino alkyl (meth)acrylate, wherein the alkyl has 1 to 4 carbon atoms.

In some embodiments, the (meth)acrylate polymer is prepared from reactants including one or more of the above monomers and comonomers, such as methyl methacrylate, ethyl methacrylate, n-butyl methacrylate, isobornyl methacrylate, phenyl methacrylate, styrene, or combinations thereof.

The (meth)acrylate polymer can have a glass transition temperature (Tg) of at least about −60° C., at least about −50° C., at least about −40° C., at least about −30° C., at least about −20° C., at least about −10° C., or at least about 0° C. The (meth)acrylate polymer can have a glass transition temperature no greater than about 80° C., no greater than about 70° C., no greater than about 60° C., no greater than about 50° C., no greater than about 40° C., no greater than about 30° C., no greater than about 20° C., or no greater than about 10° C. The Tg can be determined by using, for example, differential scanning calorimetry (DSC).

The (meth)acrylate polymer can have any useful weight average molecular weight. The weight average molecular weight (Mw) of the (meth)acrylate polymer can be at least about 50,000 grams per mole, at least about 60,000 grams per mole, at least about 70,000 grams per mole, at least about 80,000 grams per mole, or at least about 90,000 grams per mole. The weight average molecular weight of the (meth)acrylate polymer can be no greater than about 200,000 grams per mole, no greater than about 160,000 grams per mole, no greater than about 120,000 grams per mole, no greater than about 80,000 grams per mole, or no greater than about 40,000 grams per mole.

The (meth)acrylate polymer may contain —COOH groups in an amount of no more than about 1.2 wt %, no more than about 0.7 wt %, or no more than about 0.25 wt %, based on 100 wt % of the total weight of the (meth)acrylate polymer. The (meth)acrylate polymer may contain —COOH groups in an amount of at least about 0.00025 wt %, at least about 0.0012 wt %, or at least about 0.0025 wt %, based on 100 wt % of the total weight of the (meth)acrylate polymer.

The (meth)acrylate polymer may be used in an amount of at least about 50 wt %, particularly at least about 60 wt %, more particularly at least about 65 wt %, and most particularly at least about 70 wt %, based on 100 wt % of the total weight of the adhesive mixture. The (meth)acrylate polymer may be used in an amount of no higher than about 99.5 wt %, particularly no higher than about 95 wt %, more particularly no higher than about 90 wt %, and most particularly no higher than about 85 wt %, based on 100 wt % of the total weight of the adhesive mixture.

The adhesive mixture may further contain a crosslinking agent. The crosslinking agent may have a function of increasing cohesive strength of the adhesive. The crosslinking agent may be any agent used for adhesives, and can be selected from isocyanates, metal chelate crosslinking agents, and benzophenones. Particularly, a crosslinking agent selected from isocyanates and metal chelate crosslinking agents is used.

Specifically, the isocyanate crosslinking agent may be selected from toluene 2,4-diisocyanate, toluene 2,6-diisocyanate, polyaryl polymethylene isocyanate, trimethylolpropane tolylene diisocyanate and isophorone diisocyanate.

The metal chelate crosslinking agent may be compounds prepared by coordinating multivalent metal such as Al, Fe, Zn, Sn, Ti, Sb, Mg, and V with acetylacetone or ethyl acetoacetate.

The crosslinking can be performed, for example, under initiation by heat or UV irradiation, as well known in the art.

Some commercially available crosslinking agents can be used herein. Examples include, but are not limited to, those under tradenames of EC-92 (from Eternal, Taiwan), L-45 (from Soken, China) and L-75 (from Bayer, China).

The crosslinking agent may be used in an amount of at least about 0.1 wt %, at least about 0.2 wt %, at least about 0.4 wt %, at least about 0.6 wt %, at least about 0.8 wt %, at least about 1.0 wt %, at least about 2.0 wt %, or at least about 3.0 wt %, based on 100 wt % of the total weight of the adhesive mixture. The crosslinking agent may be used in an amount of no higher than about 40 wt %, no higher than about 35 wt %, no higher than about 30 wt %, no higher than about 25 wt %, no higher than about 20 wt %, no higher than about 15 wt %, no higher than about 10 wt %, no higher than about 8 wt %, or no higher than about 6 wt %, based on 100 wt % of the total weight of the adhesive mixture.

The adhesive mixture may include other additives, such as a plasticizer, for example, one or more selected from dioctyl phthalate, dibutyl phthalate, dioctyl terephthalate, diisononyl phthalate, dioctyl adipate, or dioctyl sebacate.

Amount of the plasticizer may be in the range of about 0.5 wt % to about 70 wt %, more particularly about 1 wt % to about 50 wt %, based on 100 wt % of the total weight of the adhesive mixture.

Particularly, for the convenience of application of the adhesive mixture, the (meth)acrylate polymer may be used in the form of a solution. The solvent can be any polar or non-polar solvents, such as one or more selected from aliphatic hydrocarbons, halogenated aliphatic hydrocarbons, alcohols, esters, ethers, ketones, aromatic hydrocarbons, halogenated aromatic hydrocarbons, or a mixture thereof. The solvent can be selected from C1-6 aliphatic hydrocarbons, halogenated C1-6 aliphatic hydrocarbons, C1-6 alcohols, C1-6 carboxylic acid C1-6 alkyl esters, C1-6 alkyl C1-6 alkyl ethers, C3-C12 ketones, C5-12 aromatic hydrocarbons, halogenated C5-12 aromatic hydrocarbons, and a mixture thereof. Halogenated C1-6 aliphatic hydrocarbons are C1-6 aliphatic hydrocarbons substituted by one or more fluorine, chlorine, bromine or iodine atoms. Halogenated C5-12 aromatic hydrocarbons are C5-12 aromatic hydrocarbons substituted by one or more fluorine, chlorine, bromine or iodine atoms. The solvent may be one or more selected from ethyl acetate, toluene, methanol, ethanol, or isopropanol.

The (meth)acrylate polymer may be commercially available (meth)acrylate based adhesive solutions. Examples thereof include, but are not limited to, those under tradenames of 77125 (from Eternal Chemical Company, Ltd., Taiwan), 77159 (from Eternal Chemical Company, Ltd., Taiwan), M012 (from Eternal Chemical Company, Ltd., Taiwan), PS-8243 (from SUMEI Chemical Co., LTD., Taiwan), CSA5431 (from 3M Company, China), CSA5310 (from 3M Company, China) and CSA5210 (from 3M Company, China).

Particularly, the (meth)acrylate polymer may be acid-free (meth)acrylate based pressure sensitive adhesives.

More particularly, the (meth)acrylate polymer in the form of a solution may be an acid-free (meth)acrylate based pressure sensitive adhesive solution. The acid-free (meth)acrylate based pressure sensitive adhesive solution may contain —COOH groups in an amount of no more than about 0.5 wt %, no more than about 0.3 wt %, or no more than about 0.1 wt %, based on 100 wt % of the total weight of the (meth)acrylate based pressure sensitive adhesive solution. The acid-free (meth)acrylate based pressure sensitive adhesive solution may contain —COOH groups in an amount of at least about 0.0001 wt %, at least about 0.0005 wt %, or at least about 0.001 wt %, based on 100 wt % of the total weight of the (meth)acrylate based pressure sensitive adhesive solution. Examples of the acid-free (meth)acrylate based pressure sensitive adhesive solutions include, but are not limited to, those under tradenames of 77125 (from Eternal Chemical Company, Ltd., Taiwan), 77159 (from Eternal Chemical Company, Ltd., Taiwan), M012 (from Eternal Chemical Company, Ltd., Taiwan), PS-8243 (from SUMEI Chemical Co., LTD., Taiwan), CSA5431 (from 3M Company, China), CSA5310 (from 3M Company, China) and CSA5210 (from 3M, China).

In some embodiments, the (meth)acrylate polymer is used as a solution, and the amount of the (meth)acrylate polymer in the adhesive mixture is at least about 5 wt %, particularly at least about 9 wt %, more particularly at least about 12 wt %, and most particularly at least about 15 wt %, based on 100 wt % of the total weight of the adhesive mixture. The (meth)acrylate polymer can be used in an amount of no greater than about 60 wt %, particularly no greater than about 55 wt %, more particularly no greater than about 50 wt %, and most particularly no greater than about 45 wt %, based on 100 wt % of the total weight of the adhesive mixture. In view of a suitable coating speed and an appropriate period of time for evaporating the solvent, as well as preventing bubbles from appearing in the dried adhesive, the amount of the (meth)acrylate polymer is at least about 5 wt %. On the other hand, if the amount of the (meth)acrylate polymer is above about 60 wt %, it may be hard to coat because of the high viscosity of the adhesive mixture, especially when being used as pressure sensitive adhesive.

In some embodiments, the (meth)acrylate polymer is used as a solution, and the amount of the crosslinking agent in the adhesive mixture is at least about 0.1 wt %, particularly at least about 0.2 wt %, more particularly at least about 0.3 wt %, and most particularly at least about 0.5 wt %, based on 100 wt % of the total weight of the adhesive mixture. The crosslinking agent can be used in an amount of no greater than 10 wt %, particularly no greater than about 8 wt %, more particularly no greater than about 6 wt %, and most particularly no greater than about 5 wt %, based on 100 wt % of the total weight of the adhesive mixture. If the amount of the crosslinking agent is below about 0.1 wt %, there might be residue left when using an adhesive prepared from the adhesive mixture or a protective film including an adhesive layer formed by coating with the adhesive mixture. If the amount of the crosslinking agent is above about 10 wt %, the pilot-life of the adhesive prepared from the adhesive mixture may be very short before coating, which will make the adhesive difficult to handle during manufacturing.

In some embodiments, the (meth)acrylate polymer is used as a solution, and the amount of the plasticizer may be in the range of about 0.2 wt % to about 28 wt %, more particularly about 0.4 wt % to about 20 wt %, based on 100 wt % of the total weight of the adhesive mixture.

Particularly, the (meth)acrylate polymer based adhesive mixture and the adhesive (also referred to as “adhesive composition”) prepared from the adhesive mixture is optically transparent. As used herein, the term “optically transparent” refers to an adhesive having a high optical luminous transmittance. In some embodiments, the luminous transmittance (in the range 400 nanometers to 700 nanometers) of a dried sample of the adhesive prepared from the adhesive mixture having a thickness of approximately 25 micrometers (0.001 inch) is at least 90% when measured with a spectrophotometer. In some embodiments, the composition has a low haze, as measured with, for example, a spectrophotometer. In some embodiments, the haze value is less than about 5%, less than about 4%, less than about 3%, less than about 2.8%, less than about 2.6%, less than about 2.5%, less than about 2.4%, less than about 2.2%, less than about 2%, or less than about 1.5%. Both the haze and the percent luminous transmission can be measured using the method of ASTM D1003-07.

The weak alkaline metal imide or amine is added into the (meth)acrylate polymer to react with —COOH acid groups in the polymer. After the reaction, the adhesive is obtained and can be used to form an adhesive layer, e.g. of a screen protective film. As a result, the amount of free acid group in the polymer decreases significantly, and in turn the possibility of acid-etching of the organic surface of the screen is reduced. Therefore, the appearance of the acid-etched ghosting on the surface of the screen can be alleviated.

The weak alkaline metal imide or amine has a pKa of at least about 11.0, particularly at least about 12.0, and most particularly at least about 13.0. The weak alkaline metal imide or amine has a pKa of no more than about 20.0, particularly no more than about 18.0, and most particularly no more than about 16.0. If the pKa of the weak alkaline metal imide or amine is below about 11.0, the alkaline will be too weak to react with —COOH group. If the pKa of the weak alkaline metal imide or amine is above about 20.0, it will be difficult to operate during mixing process because the alkaline is too strong.

The weak alkaline metal imide or amine used herein is compatible with the (meth)arylate polymer. The term “compatible” means that the weak alkaline metal imide or amine is soluble in the (meth)arylate polymer or soluble in a solvent which also dissolves the (meth)arylate polymer.

In some embodiments, the weak alkaline metal imide suitable for being used herein comprises a metal cation, such as an alkali metal cation, or an alkaline earth metal cation, including Li⁺, Na⁺, K⁺, Cs⁺, Mg²⁺, Ca²⁺, and Ba²⁺.

The weak alkaline metal imide suitable for being used herein may be represented by Formula 1:

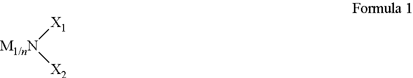

wherein:

M represents a metal cation, n is the valence of M, which is 1 or 2; and

X₁ and X₂ each independently represent C1-C12 alkyl, C1-C12 haloalkyl, C1-C12 alkyl sulfonyl, C1-C12 haloalkyl sulfonyl, C1-C12 alkyl sulfinyl, C1-C12 haloalkyl sulfinyl, C1-C12 alkyl carbonyl, C1-C12 haloalkyl carbonyl, C1-C12 alkyl sulfonyloxy, C1-C12 haloalkyl sulfonyloxy, C1-C12 alkyl sulfinyloxy, C1-C12 haloalkyl sulfinyloxy, C1-C12 alkyl carbonyloxy, C1-C12 haloalkyl carbonyloxy, (C1-C12 alkyl)-amino, (C1-C12 alkyl)₂-amino, (C1-C12 haloalkyl)-amino, (C1-C12 haloalkyl)₂-amino, (C1-C12 alkyl sulfonyl)-amino, (C1-C12 alkyl sulfonyl)₂-amino, (C1-C12 haloalkyl sulfonyl)-amino, (C1-C12 haloalkyl sulfonyl)₂-amino, (C1-C12 alkyl sulfinyl)-amino, (C1-C12 alkyl sulfinyl)₂-amino, (C1-C12 haloalkyl sulfinyl)-amino, (C1-C12 haloalkyl sulfinyl)₂-amino, C1-C12 alkyl carbonyl, C1-C12 haloalkyl carbonyl, C6-C12 aryl, C6-C12 aryl-C1-C12 alkyl, C1-C12 alkyl-C6-C12 aryl, C5-C12 mono- or bi-cyclic heteroaryl containing one to eight, one to six, or one to four heteroatoms selected from N, O, or S, which are optionally further substituted by one or more groups selected from C1-C12 alkyl, C1-C12 haloalkyl, C1-C12 alkyl sulfonyl, C1-C12 haloalkyl sulfonyl, halogen, or carboxyl. The C1-C12 alkyl can be C1-C8 alkyl, or C1-C6 alkyl, and examples thereof include but are not limited to methyl, ethyl, n-propyl, iso-propyl, n-butyl, iso-butyl, tert-butyl, pentyl, hexyl, heptyl, and octyl. C1-C12 haloalkyl refers to a C1-C12 alkyl as above substituted with one or more halogen atoms selected from F, Cl, Br, or I. In some embodiments, the C1-C12 haloalkyl is C1-C12 perfluoroalkyl. Examples of C6-C12 aryl include but are not limited to phenyl, naphthyl, and indenyl. Examples of C5-C12 mono- or bi-cyclic heteroaryl include but are not limited to pyrrolyl, pyrazolyl, imidazolyl, triazolyl, tetrazolyl, pyridazinyl, pyridinyl, pyrimidinyl, pyrazinyl, triazinyl, tetrazinyl, indazolyl, benzimidazolyl, benzotriazoly, quinolinyl, quinazolinyl, quinoxalinyl, naphthyridinyl, phthalazinyl, benzotriazinyl, pyridopyridazinyl, benzotetrazinyl, pterin ring, and purine ring.

Particularly, M represents an alkali metal cation with n being 1, or an alkaline earth metal cation with n being 2, such as Li⁺, Na⁺, K⁺, Cs⁺, Mg²⁺, Ca²⁺, and Ba²⁺. More particularly, M is Li⁺, Na⁺, K⁺, Mg⁺, or Ca²⁺. In some embodiments, M is Li⁺.

Particularly, X₁ and X₂ each independently represent C1-C12 alkyl sulfonyl, C1-C12 haloalkyl sulfonyl, C6-C12 aryl, C6-C12 aryl-C-1C12 alkyl, C5-C12 mono- or bi-cyclic heteroaryl containing one to four heteroatoms selected from N, O, or S, which are optionally substituted by one or more groups selected from C1-C12 alkyl, C1-C12 haloalkyl, fluorine, chlorine, bromine, or carboxyl.

More particularly, X₁ and X₂ each independently represent perfluoro C1-C12 alkyl sulfonyl, C6-C12 aryl which are optionally substituted by one or more C1-C12 alkyl, C6-C12 aryl-C1-C12 alkyl, or C5-C12 mono- or bi-cyclic heteroaryl containing one to four N atoms.

The weak alkaline metal imide of Formula 1 is also represented by MN(X₁X₂) herein.

The weak alkaline amine suitable for being used herein may be represented by Formula 2:

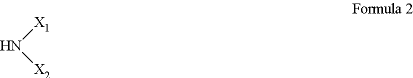

wherein X₁ and X₂ are as defined above.

The weak alkaline amine of Formula 2 is also represented by HN(X₁X₂) or (X₁X₂)NH herein.

In some embodiments, the weak alkaline amine suitable for being used herein may be represented by Formula 3:

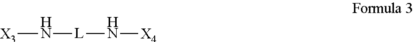

wherein L represents a direct bond, C1-C12 alkyl or C1-C12 haloalkyl, which are optionally further substituted by one or more groups selected from C1-C12 alkyl, C1-C12 haloalkyl, halogen, or carboxyl, and X₃ and X₄ are groups as defined for X₁ and X₂ above.

Examples of X₁, X₂, X₃ and X₄ include n-C₄H₉, —CH₃, —SO₂CF₃, CF₃COO—, C₄F₉SO₃—, C₃F₇COO—, CF₃SO₃—, (CF₃SO₂)₂N—, (CF₃SO₂)₃C—, (C₂F₅SO₂)₂N—, (CF₃SO₂)N—, —C₂H₄NHC₆H₃(C₃H₇), —C₆H₃(C₃H₇)₂, —C₆H₅CH₂, and —C₅N₄H₃.

Examples of the weak alkaline metal imide or amine suitable for being used herein include, but are not limited to, lithium bis(trifluoromethanesulfonyl)imide, sodium bis(trifluoromethanesulfonyl)imide, potassium bis(trifluoromethanesulfonyl)imide, N,N′-bis(2,6-diisopropylphenyl)ethylenediamine, 6-benzylaminopurine, hexamethylenetetramine, N-ethyldiisopropylamine, 2-(diisopropylamino)ethylamine, di-n-butylamine, and dipentylamine.

Some commercially available weak alkaline metal imide or amine can be used herein. Examples include, but are not limited to, lithium bis(trifluoromethanesulfonyl)imide (from 3M Company, China), N,N′-bis(2,6-diisopropylphenyl)ethylenediamine (from Jiaxing Sicheng Chemical, China) and 6-benzylaminopurine (from Shanghai Yanyu Biological Technology Co., LTD, China).

Without being bound to any specific theory, the mechanisms of the elimination or alleviation of —COOH acid groups are illustrated below.

The free —COOH acid groups in the (meth)acrylate polymer are transformed to the salt form by the following reactions between —COOH groups and the weak alkaline metal imide or amine.

The reaction mechanism between —COOH acid groups and a weak alkaline metal imide in the adhesive mixture, for example, of Formula 1 when M is a metal cation with n being 1, is as follows:

MN(X₁X₂)+R—COOH→R—COOM+HN(X₁X₂)

where M, X₁ and X₂ are as defined above for Formula 1, and R represents a (meth)acrylate polymer chain to which —COOH groups are attached.

The reaction mechanism between —COOH acid group and a weak alkaline amine in the adhesive mixture is as follows:

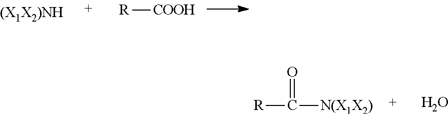

where X₁ and X₂ are as defined above for Formula 2, and R represents a (meth)acrylate polymer chain to which —COOH groups are attached.

The weak alkaline metal imide or amine can be added into the polymer as solid or solution in an organic solvent. The organic solvents can be any polar or apolar solvents, such as one or more selected from aliphatic hydrocarbons, halogenated aliphatic hydrocarbons, alcohols, esters, ethers, ketones, aromatic hydrocarbons, halogenated aromatic hydrocarbons, or a mixture thereof. The solvent can be selected from C1-6 aliphatic hydrocarbons, halogenated C1-6 aliphatic hydrocarbons, C1-6 alcohols, C1-6 carboxylic acid C1-6 alkyl esters, C1-6 alkyl C1-6 alkyl ethers, C3-C12 ketones, C5-12 aromatic hydrocarbons, halogenated C5-12 aromatic hydrocarbons, and a mixture thereof. Halogenated C1-6 aliphatic hydrocarbons are C1-6 aliphatic hydrocarbons substituted by one or more fluorine, chlorine, bromine or iodine atoms. Halogenated C5-12 aromatic hydrocarbons are C5-12 aromatic hydrocarbons substituted by one or more fluorine, chlorine, bromine or iodine atoms. The solvent may be one or more selected from ethyl acetate, toluene, methanol, ethanol, or isopropanol.

When the weak alkaline metal imide or amine is used in the form of a solution, the concentration of the weak alkaline metal imide or amine in the solution can be above about 0.001 wt %, above about 0.01 wt %, above about 0.1 wt %, above about 1 wt %, above about 5 wt %, above about 10 wt %, above about 15 wt %, or about above 20 wt %, above about 30 wt %, or above about 40 wt %, and below about 50 wt %, below about 45 wt %, below about 40 wt %, below about 35 wt %, below about 30 wt %, below about 25 wt %, below about 20 wt %, below about 15 wt %, below about 10 wt %, below about 5 wt %, below about 2 wt %, below about 1.5 wt %, or below about 1 wt %. Particularly, the weak alkaline metal imide or amine may be used in the form of a solution having a concentration in the range of about 0.001 wt % to about 30.0 wt %, particularly in the range of about 0.01 wt % to about 20 wt %, and most particularly in the range of about 0.1 wt % to about 10.0 wt %.

In one embodiment, the weak alkaline metal imide or amine is used in a form of a 1 wt % solution in ethyl acetate. The solution of the weak alkaline metal imide or amine has a pH in the range of 7.2-9.0, particularly in the range of 7.5-8.5, more particularly in the range of 7.5-8.2, and most particularly in the range of 7.5-8.0.

The amount of the weak alkaline metal imide or amine is added in such an amount that the molar ratio of the weak alkaline metal imide or amine to the —COOH groups contained in the (meth)acrylate polymer is in a range of about 1.0 to about 5.0, more particularly in a range of about 1.2 to about 4.0, and most particularly in a range of about 1.2 to about 2.0. If the molar ratio of the weak alkaline metal imide or amine to the —COOH groups contained in the (meth)acrylate polymer is below 1.0, the —COOH group cannot be completely neutralized. On the other hand, if the molar ratio of the weak alkaline metal imide or amine to the —COOH groups contained in the (meth)acrylate polymer is above 5.0, it will cause a significant increase of peel force of the resultant adhesive or protective film and leave residue on substrate.

The amount of —COOH groups contained in the (meth)acrylate polymer can be determined by titration.

The weak alkaline metal imide or amine can be added in the form of a solution in a predetermined amount into a (meth)acrylate polymer. The resultant adhesive mixture is mixed for 10 to 120 min, particularly 20 to 90 min, more particularly 30 to 60 min, at a temperature of 10 to 50° C., more particularly 15 to 40° C., and most particularly 20 to 30° C., to allow the weak alkaline metal imide or amine uniformly distribute into the (meth)acrylate polymer solution. During the mixing process, part of weak alkaline metal imide or amine may react with the —COOH groups. In one embodiment, the resultant adhesive mixture is mixed for 30 min at room temperature.

After mixing all components in mixture, the mixture will be coated on backing layer, and then dried in an oven for 1 to 20 min, particularly 2 to 15 min, more particularly 1 to 10 min. The temperature of the oven is at least 20° C., particularly at least about 30° C., more particularly at least about 35° C., and most particularly at least about 40° C. The temperature of the oven is no higher than 200° C., particularly no higher than about 160° C., more particularly no higher than about 140° C., and most particularly no higher than about 120° C. The drying process may allow most of the solvent to evaporate form the coated solution, and to allow the weak alkaline metal imide or amine react with most of the —COOH groups. Thus, an adhesive layer is formed on the backing layer and such adhesive layer has the advantage of alleviating the possibility of permanent ghosting marks appeared on a substrate, e.g. the mobile screen, thanks to very tiny amount or even scarcely any of —COOH groups in the adhesive layer.

The peel strength is a measure of the force applied to remove (peel) a substrate or sheet material coated with the adhesive from a test panel at 180° peel angle. In some embodiments, the adhesive prepared from the adhesive mixture can have a peeling strength, determined by the test described herein below, of at least 5 g/inch, at least 8 g/inch, or at least 12 g/inch. In other embodiments, the adhesive can have a peel strength, determined by the test described herein below, of no more than 200 g/inch, no more than 150 g/inch, or no more than 100 g/inch.

The adhesive has a sufficient cohesive strength to be removed cleanly from the substrate. In some embodiments, the adhesive can be removed from the substrate without leaving any residual adhesive.

In some embodiments, an adhesive formed from the above adhesive mixture is provided. The amount of —COOH groups contained in the adhesive is below about 0.01 wt %, particularly below about 0.005 wt %, more particularly below about 0.001 wt %, and most particularly below about 0.0005 wt %. In the embodiments where the (meth)acrylate polymer in the adhesive mixture is used in the form of a solution, the adhesive is obtained by removing most of the solvent and the residual amount of solvent in the adhesive is no greater than about 8 wt %, based on the total weight of the dried adhesive.

In some embodiments, a protective film is provided. The film includes a backing layer and an adhesive layer supported by the backing layer. Alternatively, the film includes a backing layer having a first surface and the adhesive layer in contact with the first surface of the backing layer. The adhesive layer is formed by an adhesive mixture including a (meth)acrylate polymer and a weak alkaline metal imide or amine. The weak alkaline metal imide or amine has a pKa of 11 to 20 and the molar ratio of the weak alkaline metal imide or amine to the —COOH groups contained in the (meth)acrylate polymer is in a range of 1.0-5.0.

There is no limitation to the backing layer suitable for the present invention. Any conventional backing layer material used in the present field may be used herein. For example, the backing layer may be a super thin film (for example, a film with a thickness less than about 150 μm, particularly less than about 120 μm, more particularly less than about 100 μm) of polymers, such as a film of polyolefins, polyimides, or polyesters, e.g. polyethylene, polypropylene, poly(bismaleimide), poly(ether imide), poly(pyromellitimide-1,4-diphenyl ether), polyethylene terephthalate (PET), or polybutylene terephthalate (PBT). In some embodiments, the film comprises an optically clear pressure sensitive adhesive layer. In some embodiments, the backing layer can be flexible or rigid. The film can be, for example, used as a protective article (e.g., protective tape or cover).

The adhesive mixture can be applied to the backing layer by coating the mixture onto the backing layer, or by extruding the mixture onto the backing layer, to form the adhesive layer. Any conventional means in the art for applying an adhesive layer on a backing layer can be used herein, such as spin coating, gravure coating, roll coating, rod coating, slit coating, extrusion coating, doctor blade coating, cascade coating, curtain coating, spin coating, or immersion coating.

In some embodiments, the dried adhesive layer can have a thickness of at least about 1 μm, at least about 3 μm, or at least about 5 μm. In some embodiments, the dried adhesive layer can have a thickness of no more than about 80 μm, no more than about 50 μm, or no more than about 30 μm.

In some embodiments, the film further comprises a protective liner in contact with the adhesive layer. The protective liner protects the adhesive layer until the film is ready for application to a substrate, i.e. when the protective liner is removed so that the adhesive layer is exposed. The protective liner, often referred to as a release liner, can be any type commonly used in the art. Examples of materials that can be used for the liner include, but are not limited to: glassine paper, laminated paper, polyester film and polypropylene film, particularly each of which has been subjected to a coating of a silicone containing material, a fluorine containing material or some other low surface energy material.

The film is suitable for protecting screens with surfaces made of various organic materials. Particularly, the surfaces of the screens are made of polymers, such as homopolymers and copolymers. Examples of the materials of the surfaces include but are not limited to polyesters such as polyethylene terephthalate (PET) and polybutylene terephthalate (PBT), polycarbonates (PC), acrylonitrile-butadiene-styrene (ABS), polyimides, polyolefines such as polypropylene, and (meth)acrylate polymers such as polymethylmethacrylate (PMMA).

The film as described above can be prepared by a method comprising steps of:

(b) adding a weak alkaline metal imide or amine into a (meth)acrylate polymer to obtain a mixture, wherein the weak alkaline metal imide or amine has a pKa of 11 to 20, and the molar ratio of the weak alkaline metal imide or amine to the —COOH groups contained in the (meth)acrylate polymer is in a range of 1.0-5.0;

(c) applying the mixture obtained in step (b) on at least part of a backing layer to form an adhesive layer; and

(d) drying the backing layer and the adhesive layer.

Alternatively, the method further comprises a step of (a) determining the amount of —COOH groups in a (meth)acrylate polymer before step (b).

The amount of —COOH groups in a (meth)acrylate polymer can be determined by titration. The titrant can be selected from alkalines such as alkali metal hydroxides and alkaline earth metal hydroxides. Examples thereof include but are not limited to sodium hydroxide, potassium hydroxide, lithium hydroxide, magnesium hydroxide, etc.

In some embodiments, the titrant is used as a solution in a mixture of water and one or more organic solvents, so as to achieve a high solubility of the alkaline and a good compatibility with the (meth)acrylate polymer. The organic solvent can be selected from those which are miscible with water, such as alcohols, ethers, ketones, aldehydes, and the like. Examples thereof include but are not limited to C1-6 alcohols, C1-6 alkyl C1-6 alkyl ethers, C3-C6 ketones, C1-6 aldehydes, such as methanol, ethanol, n-propanol, iso-propanol, ethyl ether, acetone, butanone, formaldehyde, acetaldehyde, propionaldehyde, and butyraldehyde.

The amount of water in the solvent mixture is above about 0.5 vol %, above about 1 vol %, above about 2 vol %, above about 3 vol %, or above about 4 vol %, and below about 30 vol %, below about 25 vol %, below about 20 vol %, below about 15 vol %, or below about 10 vol %. The amount of the organic solvent in the solvent mixture is above about 70 vol %, above about 75 vol %, above about 80 vol %, above about 85 vol %, or above about 90 vol %, and below about 99.5 vol %, below about 99 vol %, below about 98 vol %, below about 97 vol %, or below about 96 vol %.

In some embodiment, a mixture of water and ethanol is used. In some embodiments, a mixture of about 5 vol % of water and about 95 vol % of ethanol is used.

The concentration of the alkaline solution used as the titrant for titration is in a range of 0.01-2 mol/L, particularly in a range of 0.02-1.5 mol/L, more particularly in a range of 0.05-1 mol/L, and most particularly in a range of 0.08-0.5 mol/L.

The indicator can be any one commonly used in the titration of an acid, examples thereof include but are not limited to phenolphthalein, bromothymol blue, phenol red, and neutral red. In some embodiments, 1% phenolphthalein in ethanol is used as the indicator. The amount of the indicator is as conventionally used in the art.

The (meth)acrylate polymer is accurately weighed and dissolved in a solvent or a mixture of solvents. The solvent or the mixture of solvents should not only be capable of dissolving the (meth)acrylate polymer but also have good compatibility with the solvent used for the titrant. The solvent for dissolving the (meth)acrylate polymer can be selected from polar or non-polar solvents, such as aliphatic hydrocarbons, halogenated aliphatic hydrocarbons, alcohols, esters, ethers, ketones, aromatic hydrocarbons, halogenated aromatic hydrocarbons, or a mixture thereof. The solvent can be selected from C1-6 aliphatic hydrocarbons, halogenated C1-6 aliphatic hydrocarbons, C1-6 alcohols, C1-6 carboxylic acid C1-6 alkyl esters, C1-6 alkyl C1-6 alkyl ethers, C3-C6 ketones, C1-6 aldehydes, C5-12 aromatic hydrocarbons, halogenated C5-12 aromatic hydrocarbons, or a mixture thereof. Examples of the solvent include, but are not limited to: benzene, toluene, xylene, cyclohexane, methanol, ethanol, n-propanol, iso-propanol, ethyl ether, acetone, butanone, formaldehyde, acetaldehyde, propionaldehyde, and butyraldehyde. The mixture of solvents can be composed of two or more of the solvents as described above. In some embodiments, a mixture of two solvents in a weight ratio of about 1:5 to about 5:1, or about 1:3 to about 3:1 is used.

In some embodiments, the solvent or the mixture of solvents used for dissolving the (meth)acrylate polymer might contain acid, so the solvent or the mixture is titrated to neutral before use. The titration of the solvent can be carried out by using any alkaline as described for the titrant and any indicator as described above. Conveniently, the same titrant solution and indicator are used for the titration of the solvent and the (meth)acrylate polymer.

Specifically, the titration can be carried out as follows. A sample of m g of a (meth)acrylate polymer is accurately weighed into a flask, and about 50 mL of a solvent or a solvent mixture which has been titrated to neutral by an alkaline before use to remove any acid contained therein is added, with 4 to 5 drops of an indicator solution added. The sample is shaken to dissolve, and a mild heat can be applied to facilitate dissolution. The sample is titrated with a titrant solution in a concentration of x mol/L until the solution turns light red, and the volume of the titrant solution used is recorded as V (L). When the titrant is MOH, the mass ratio of —COOH is calculated as 45*V*x/m, and when the titrant is M(OH)₂, the mass ratio of —COOH is calculated as 45*V*x*2/m, where M is a metal ion, and 45 is the molar weight of —COOH (g/mol).

After the amount of —COOH groups in the (meth)acrylate polymer is determined, a weak alkaline metal imide or amine is added into the (meth)acrylate polymer to obtain a mixture, wherein the weak alkaline metal imide or amine has a pKa of 11 to 20, and the molar ratio of the weak alkaline metal imide or amine to the —COOH groups contained in the (meth)acrylate polymer is in a range of 1.0-5.0. The weak alkaline metal imide or amine is as described above. The weak alkaline metal imide or amine can be added in the form of a solution in a predetermined amount into the (meth)acrylate based pressure sensitive adhesive. The resultant adhesive mixture may be mixed for 10 to 120 min, particularly 20 to 90 min, more particularly 30 to 60 min, at a temperature of 10 to 50° C., more particularly 15 to 40° C., and most particularly 20 to 30° C., to allow the weak alkaline metal imide or amine uniformly distribute into the (meth)acrylate polymer solution. In one embodiment, the resultant adhesive mixture is mixed for 30 min at room temperature.

The adhesive mixture obtained above is then applied to a backing layer by coating the mixture onto the backing layer, or by extruding the mixture onto the backing layer, to form the adhesive layer. Any conventional means in the art for applying an adhesive layer on a backing layer can be used herein, such as spin coating, gravure coating, roll coating, rod coating, slit coating, extrusion coating, doctor blade coating, cascade coating, curtain coating, spin coating, or immersion coating.

Particularly, for the convenience of application process, a solvent may be added into the adhesive mixture to obtain an adhesive solution. The solvent can be any polar or non-polar solvents, such as one or more selected from aliphatic hydrocarbons, halogenated aliphatic hydrocarbons, alcohols, esters, ethers, ketones, aromatic hydrocarbons, halogenated aromatic hydrocarbons, or a mixture thereof. The solvent can be selected from C1-6 aliphatic hydrocarbons, halogenated C1-6 aliphatic hydrocarbons, C1-6 alcohols, C1-6 carboxylic acid C1-6 alkyl esters, C1-6 alkyl C1-6 alkyl ethers, C5-12 aromatic hydrocarbons, halogenated C5-12 aromatic hydrocarbons, and a mixture thereof. Halogenated C1-6 aliphatic hydrocarbons are C1-6 aliphatic hydrocarbons substituted by one or more fluorine, chlorine, bromine or iodine atoms. Halogenated C5-12 aromatic hydrocarbons are C5-12 aromatic hydrocarbons substituted by one or more fluorine, chlorine, bromine or iodine atoms. The solvent may be one or more selected from ethyl acetate, toluene, methanol, ethanol, or isopropanol.

The solvent used for the adhesive solution and the solvent used for the weak alkaline metal imide or amine may be the same, or may be different from each other.

In the adhesive solution, the solvent may comprise at least about 40 wt %, particularly at least about 45 wt %, more particularly at least about 50 wt %, and most particularly at least about 55 wt %, based on 100 wt % of the total weight of the adhesive solution. In the adhesive solution, the solvent may comprise no greater than about 95 wt %, particularly no greater than about 91 wt %, more particularly no greater than about 88 wt %, and most particularly no greater than about 85 wt %, based on 100 wt % of the total weight of the adhesive solution. If the amount of the solvent is below about 40 wt %, it will be hard to coat because of high viscosity of pressure sensitive adhesive. In view of a suitable coating speed and an appropriate period of time for evaporating the solvent, as well as preventing bubbles from appearing in the dried adhesive, the amount of the solvent is no greater than about 95 wt %.

In the adhesive solution, the (meth)acrylate polymer may comprise at least about 5 wt %, particularly at least about 9 wt %, more particularly at least about 12 wt %, and most particularly at least about 15 wt %, based on 100 wt % of the total weight of the adhesive solution. In the adhesive solution, the (meth)acrylate polymer may comprise no greater than about 60 wt %, particularly no greater than about 55 wt %, more particularly no greater than about 50 wt %, and most particularly no greater than about 45 wt %, based on 100 wt % of the total weight of the adhesive solution.

In the adhesive solution, the crosslinking agent may comprise at least about 0.1 wt %, particularly at least about 0.2 wt %, more particularly at least about 0.3 wt %, and most particularly at least about 0.5 wt %, based on 100 wt % of the total weight of the adhesive solution. In the adhesive solution, the crosslinking agent may comprise no greater than 10 wt %, particularly no greater than about 8 wt %, more particularly no greater than about 6 wt %, and most particularly no greater than about 5 wt %, based on 100 wt % of the total weight of the adhesive solution.

In the adhesive solution, the plasticizer may comprise about 0.2 wt % to about 28 wt %, more particularly about 0.4 wt % to about 20 wt %, based on 100 wt % of the total weight of the adhesive solution.

After the completion of the coating process, the film is dried at a temperature of 20° C. to 200° C., at a temperature of 20° C. to 150° C., or at a temperature of 20° C. to 120° C., for 1 to 200 min, until the solvent is evaporated. Optionally, the film is cured at a temperature of 30 to 200° C., at a temperature of 30 to 150° C., or at a temperature of 50 to 100° C., for 12 to 72 hours. In some embodiments, the coated film is allowed to stand at room temperature for 10 min, and then in an oven at 120° C. for 1 to 10 min to evaporate all solvent, and then in an oven at 60° C. to cure for 24 to 72 hours.

The drying process removes most of the solvent and allows weak alkaline metal imide or amine react with most of the —COOH groups. The dried adhesive layer in the film obtained only contains the solvent in an amount of no greater than about 8 wt %, particularly no greater than about 6 wt %, more particularly no greater than about 5 wt %, even more particularly no greater than about 4 wt %, and most particularly no greater than about 3 wt %, based on the total weight of the dried adhesive layer.

In the dried adhesive layer of the film prepared as above, the (meth)acrylate polymer may comprise at least about 50 wt %, particularly at least about 60 wt %, more particularly at least about 65 wt %, and most particularly at least about 70 wt %, based on 100 wt % of the total weight of the dried adhesive layer. The (meth)acrylate polymer may comprise no higher than about 99.5 wt %, particularly no higher than about 95 wt %, more particularly no higher than about 90 wt %, and most particularly no higher than about 85 wt %, based on 100 wt % of the total weight of the dried adhesive layer.

In the dried adhesive layer of the film prepared as above, the crosslinking agent may comprise at least about 0.1 wt %, at least about 0.2 wt %, at least about 0.4 wt %, at least about 0.6 wt %, at least about 0.8 wt %, at least about 1.0 wt %, at least about 2.0 wt %, or at least about 3.0 wt %, based on 100 wt % of the total weight of the dried adhesive layer. The crosslinking agent may comprise no higher than about 40 wt %, no higher than about 35 wt %, no higher than about 30 wt %, no higher than about 25 wt %, no higher than about 20 wt %, no higher than about 15 wt %, no higher than about 10 wt %, no higher than about 8 wt %, or no higher than about 6 wt %, based on 100 wt % of the total weight of the dried adhesive layer.

In the dried adhesive layer of the film prepared as above, the plasticizer may comprise at least about 0.1 wt %, particularly at least about 0.5 wt %, and most particularly at least about 1 wt %, based on 100 wt % of the total weight of the dried adhesive layer. The plasticizer may comprise no higher than about 70 wt %, particularly no higher than about 60 wt %, and most particularly no higher than about 50 wt %, based on 100 wt % of the total weight of the dried adhesive layer.

The following examples and comparative examples were provided to aid in the understanding of the present invention and are not to be construed as limiting the scope thereof. Unless otherwise indicated, all parts and percentages are by weight. The following test methods and protocols were employed in the evaluation of the illustrative and comparative examples that follow.

### EXAMPLES

In the following Examples and Comparative Examples, the following materials were used.

PET film, in a thickness of 50 μm, under the tradename of 4507 from Mitsubishi Chemical Hongkong LTD is used as a backing layer.
An adhesive solution under the tradename of 77125 from Eternal Chemical CO., LTD, Taiwan, an acrylate based pressure sensitive adhesive solution in ethyl acetate and toluene, is used as a (meth)acrylate polymer, wherein Tg of the acrylate polymer is −50° C., amount of the acrylate polymer is 35%, and amount of the solvent is 65%.
An isocyanate crosslinking agent under the tradename of EC-92, from Eternal Chemical CO., LTD, Taiwan, is used as a crosslinking agent.
The following alkaline metal imide or amine are used:
Lithium bis(trifluoromethanesulfonyl)imide, LiN(SO₂CF₃)₂, Mw: 287 g/mol, pKa: 13.5, a solution in ethyl acetate (EA), 1 wt %, pH: 7.6, obtained from 3M Company, China; N,N′-bis(2,6-diisopropylphenyl)ethylenediamine, (C₃H₇)₂C₆H₃NHC₂H₄NHC₆H₃(C₃H₇)₂, Mw: 380 g/mol, pKa:14, a solution in ethyl acetate, 1 wt %, pH: 7.5, obtained from Jiaxing Sicheng Chemical, China;
6-Benzylaminopurine, C₆H₅CH₂—NH—C₅N₄H₃, Mw: 225.25 g/mol, pKa:16, a solution in ethyl acetate, 1 wt %, pH: 8.0, obtained from Shanghai Yanyu Biological Technology Co., LTD, China;
Tri-n-butylmethylammonium bis(trifluoromethanesulfonyl)imide,
(n-C₄H₉)₃(CH₃)NN(SO₂CF₃)₂, Mw: 404 g/mol, pKa: 9, a solution in ethyl acetate, 1 wt %, pH: 5, obtained from 3M Company, China.
Polycarbonate (PC) sheet under the tradename of LEXAN having a thickness of 45 mm and in size of 2 inch*5 inch, from SABIC Innovative Plastics, China is used as a substrate.
Acrylonitrile-butadiene-styrene (ABS) resin sheet under the tradename of COASE PATTERNED having a thickness of 50 mm and in a size of 2 inch*5 inch, from XinHeJiu Plastic Co. Ltd., China is used as a substrate.
The following equipments are used:

### Microscope: ZIP 250 SMARTSCOPE, Optical Gaging Products (OGP), USA;

### Imass SP-2000: Instrumentor's Inc., USA.

Other chemicals and solvents are used as commercially available.

### Test Methods

### 1. Determination of Amount of —COOH Groups in Pressure Sensitive Adhesive

Chemicals used: 1 L of KOH solution at a concentration of 0.1 mol/L, wherein the solvent includes 50 mL of water and balance of ethanol; a neutral mixture of toluene and ethanol (toluene:ethanol=1:1, wt/wt), titrated to neutral by KOH (0.1 mol/L solution as described above) before use; and 1% phenolphthalein in ethanol.

An example of the procedure is described using the 77125 adhesive solution. A sample of 100 g of 77125 adhesive solution was accurately weighed into a Erlenmeyer flask, and 50 mL of a neutral mixture of toluene and ethanol (toluene:ethanol=1:1, wt/wt) was added, with 4 to 5 drops of 1% phenolphthalein in ethanol added as an indicator (the mixture of toluene and ethanol might contain acid, and was titrated to neutral by KOH before use). The sample was shaken to dissolve, and a mild heat was applied to facilitate dissolution. The sample was titrated to light red with the 0.1 mol/L KOH solution, the volume of the KOH solution used is recorded as 0.0033 L. The mass ratio of —COOH is calculated as 45*0.0033*0.1/100, where 45 is the molar weight of —COOH (g/mol), and 0.1 is the concentration of the KOH solution.

The amount of —COOH in the 77125 adhesive solution is 0.015 wt %.

### 2. Ghosting Mark Test

A protective film, with adhesive, was applied to a surface of a polycarbonate (PC) or ABS resin sheet (size: 2 inch×5 inch), pressed back and forth by a 4.5 lb pressing roll at 12 in/min. The sample was aged under conditions of, i) in an oven at 85° C. for 7 days, or ii) in an oven at 85° C./85% humidity for 7 days. The aged sample was moved out of the oven, and the protective film was peeled off. The surface of the PC or ABS resin sheet which has been covered by the protective film was wiped with isopropanol. The wiped surface was observed using a microscope (ZIP 250 SMARTSCOPE, Supplier: Optical Gaging Products (OGP), USA).

### 3. Peel Strength and Residual Adhesive Test

A strip of protective film, 1 inch in width, was applied to a surface of a polycarbonate (PC) sheet (size: 2 inch×5 inch), pressed back and forth by a 4.5 lb pressing roll at 12 in/min. The sample was aged in an oven at 85° C. for 7 days. The aged sample was moved out of the oven, allowed to stand at room temperature for 2 hours. The peel strength of peeling the protective film off the PC sheet at a 180° angle was measured at 12 inch/min by using an Imass SP-2000 tester (Supplier: Instrumentor's, Inc. USA). The PC sheet was visually for residual adhesive and amount thereof. The amount of the residual adhesive was calculated as the area of residue/total area covered by protective film.

### Examples 1-1 to 1-5

Lithium bis(trifluoromethanesulfonyl)imide with a pKa of 13.5 was used in Examples 1-1 to 1-5.

Protective films of Examples 1-1 to 1-5 were prepared by the following procedure.

77125 adhesive solution, a solution of lithium bis(trifluoromethanesulfonyl)imide in EA containing the imide in an amount as indicated in Table 1, and EC-92 in amounts as described in Table 1, were successively added into a 200 mL flask, mixed on a rolling mixer for 30 min. The resultant homogeneous adhesive mixture was applied onto a 50 μm PET film, with the dried adhesive layer in a thickness of 13 μm. The PET film was allowed to stand at room temperature for 10 min, and then in an oven at 120° C. for 10 min to evaporate all solvent, and then in an oven at 60° C. to cure for 48 hours. The protective films obtained were used for tests as described above. Test results are shown in Table 2.

TABLE 1
Formulations for Examples 1-1 to 1-5

| | 77125 | Lithium | |
|---|---|---|---|
| Exp. No. | Solution | bis(trifluoromethanesulfonyl)imide | EC-92 |
| 1-1 | 100 g | 0.096 g | 1.5 g |
| 1-2 | 100 g | 0.153 g | 1.5 g |
| 1-3 | 100 g | 0.191 g | 1.5 g |
| 1-4 | 100 g | 0.384 g | 1.5 g |
| 1-5 | 100 g | 0.670 g | 1.5 g |

TABLE 2
Test results for Examples 1-1 to 1-5

| | Ghosting Mark | | | | | |
|---|---|---|---|---|---|---|
| | PC | | ABS | | | Residual |
| | | 85° C./85% | | 85° C./85% | Peel | Adhesive |
| | 85° C./7 | Humidity/7 | 85° C./7 | Humidity/7 | Strength | After Peeling |
| Exp. No. | Days | Days | Days | Days | (g/inch) | Off |
| 1-1 | No | No | Few | Few | 5.1 | No |
| 1-2 | No | No | No | No | 6.4 | No |
| 1-3 | No | No | No | No | 8.2 | No |
| 1-4 | No | No | No | No | 13.6 | No |
| 1-5 | No | No | No | No | 18.6 | 10% Residual |
| | | | | | | Adhesive |

The molar ratios of lithium bis(trifluoromethanesulfonyl)imide to the —COOH groups in 77125 adhesive solution were 1.0, 1.6, 2.0, 4.0, and 7.0 in Examples 1-1 to 1-5, respectively. The protective film of Example 1-1 did not lead to any ghosting mark on the PC sheet, but few traces of ghosting mark on the ABS sheet, with a peel strength of 5.1 g/inch. The protective films of Examples 1-2 and 1-3 did not lead to any ghosting mark on PC and ABS sheets, with peeling strengths slightly higher than that of Example 1-1. The protective film of Example 1-4 did not lead to any ghosting mark on PC and ABS sheets, with the peel strength increased to 13.6 g/inch. The protective film of Example 1-5 did not lead to any ghosting mark on PC and ABS sheets, but the peel strength increased to 18.6 g/inch and 10% residual adhesive was observed on PC sheet.

### Examples 2-1 to 2-3

Protective films of Examples 2-1 to 2-3 were prepared by the same procedure as in Examples 1-1 to 1-5, except N,N′-Bis(2,6-diisopropylphenyl)ethylenediamine, with a pKa of 14, replaced lithium bis(trifluoromethanesulfonyl)imide, per the formulations of Table 3. The amounts of N,N′-Bis(2,6-diisopropylphenyl)ethylenediamine indicated in Table 3 were the amounts of the amine contained in the solution. Test results are shown in Table 4.

TABLE 3
Formulations for Examples 2-1 to 2-3

| | 77125 | N,N′-Bis(2,6- | |
|---|---|---|---|
| Exp. No. | Solution | diisopropylphenyl)ethylenediamine | EC-92 |
| 2-1 | 100 g | 0.150 g | 1.5 g |
| 2-2 | 100 g | 0.200 g | 1.5 g |
| 2-3 | 100 g | 0.627 g | 1.5 g |

TABLE 4
Test results for Examples 2-1 to 2-3

| | Ghosting Mark | | | | | |
|---|---|---|---|---|---|---|
| | PC | | ABS | | | Residual |
| | | 85° C./85% | | 85° C./85% | Peel | Adhesive |
| | 85° C./7 | Humidity/7 | 85° C./7 | Humidity/7 | Strength | After Peeling |
| Exp. No. | Days | Days | Days | Days | (g/inch) | Off |
| 2-1 | No | No | No | No | 6.3 | No |
| 2-2 | No | No | No | No | 8.5 | No |
| 2-3 | No | No | No | No | 15.2 | No |

The molar ratios of N,N′-bis(2,6-diisopropylphenyl)ethylenediamine to the —COOH groups in 77125 adhesive solution were 1.2, 1.6, and 5.0 in Examples 2-1 to 2-3, respectively. The protective films of Examples 2-1 and 2-2 did not lead to any ghosting mark on PC and ABS sheets, with peeling strength of Example 2-2 higher than that of Example 2-1. The protective film of Example 2-3 did not lead to any ghosting mark on PC and ABS sheets, with the peel strength increased to 15.2 g/inch, but no residual adhesive was observed on PC sheet.

### Examples 3-1 to 3-3

Protective films of Examples 3-1 to 3-3 were prepared by the same procedure as in Examples 1-1 to 1-5, except 6-Benzylaminopurine, with a pKa of 16, replaced lithium bis(trifluoromethanesulfonyl)imide per the formulations of Table 5. The amounts of 6-Benzylaminopurine indicated in Table 5 were the amounts of 6-Benzylaminopurine contained in the solution. Test results are shown in Table 6.

TABLE 5
Formulations for Examples 3-1 to 3-3

| | 77125 | | |
|---|---|---|---|
| Exp. No. | Solution | 6-Benzylaminopurine | EC-92 |
| 3-1 | 100 g | 0.097 g | 1.5 g |
| 3-2 | 100 g | 0.126 g | 1.5 g |
| 3-3 | 100 g | 0.223 g | 1.5 g |

TABLE 6
Test results for Examples 3-1 to 3-3

| | Ghosting Mark | | | | | |
|---|---|---|---|---|---|---|
| | PC | | ABS | | | Residual |
| | | 85° C./85% | | 85° C./85% | Peel | Adhesive |
| | 85° C./7 | Humidity/7 | 85° C./7 | Humidity/7 | Strength | After Peeling |
| Exp. No. | Days | Days | Days | Days | (g/inch) | Off |
| 3-1 | No | No | No | No | 6.8 | No |
| 3-2 | No | No | No | No | 9.1 | No |
| 3-3 | No | No | No | No | 14.1 | No |

The molar ratios of 6-benzylaminopurine to the —COOH groups in 77125 adhesive solution were 1.3, 1.7, and 3.0 in Examples 3-1 to 3-3, respectively. The protective films of Examples 3-1 and 3-2 did not lead to any ghosting mark on PC and ABS sheets, with peeling strength of Example 3-2 higher than that of Example 3-1. The protective film of Example 3-3 did not lead to any ghosting mark on PC and ABS sheets, with the peel strength increased to 14.1 g/inch, but no residual adhesive was observed on PC sheet.

### Comparative Example 4

The protective film of Comparative Example 1 was prepared by the same procedure as in Examples 1-1 to 1-5, except that the formulation in Table 7 was used.

Test results are shown in Table 8.

TABLE 7
Formulation for Comparative Example 4

| | 77125 | |
|---|---|---|
| Comp. Exp. No. | Solution | EC-92 |
| 4 | 100 g | 1.5 g |

TABLE 8
Test results for Comparative Example 4

| | Ghosting Mark | | | | | |
|---|---|---|---|---|---|---|
| | PC | | ABS | | | Residual |
| | | 85° C./85% | | 85° C./85% | Peel | Adhesive |
| Comp. | 85° C./7 | Humidity/7 | 85° C./7 | Humidity/7 | Strength | After Peeling |
| Exp. No. | Days | Days | Days | Days | (g/inch) | Off |
| 4 | Yes | Yes | Yes | Yes | 4.1 | No |

In Comparative Example 4, no weak alkaline metal imide or amine was used. It can be seen from Table 8 that ghosting marks were observed on PC and ABS sheets covered by the protective film of Comparative Example 1.

### Comparative Examples 5-1 to 5-3

The protective films of Comparative Examples 5-1 to 5-3 were prepared by the same procedure as in Examples 1-1 to 1-5, except tri-n-butylmethylammonium bis(trifluoromethanesulfonyl)imide, with a pKa of 9, replaced lithium bis(trifluoromethanesulfonyl)imide per the formulations of Table 9. The amounts of tri-n-butylmethylammonium bis(trifluoromethanesulfonyl)imide indicated in Table 9 were the amounts of the imide contained in the solution.

Test results are shown in Table 10.

TABLE 9
Formulations for Comparative Examples 5-1 to 5-3

| | 77125 | Tri-n-butylmethylammonium | |
|---|---|---|---|
| Comp. Exp. No. | Solution | bis(trifluoromethanesulfonyl)imide | EC-92 |
| 5-1 | 100 g | 0.133 g | 1.5 g |
| 5-2 | 100 g | 0.213 g | 1.5 g |
| 5-3 | 100 g | 0.266 g | 1.5 g |

TABLE 10
Test results for Comparative Examples 5-1 to 5-3

| | Ghosting Mark | | | | | |
|---|---|---|---|---|---|---|
| | PC | | ABS | | | Residual |
| | | 85° C./85% | | 85° C./85% | Peel | Adhesive |
| Comp. | 85° C./7 | Humidity/7 | 85° C./7 | Humidity/7 | Strength | After Peeling |
| Exp. No. | Days | Days | Days | Days | (g/inch) | Off |
| 5-1 | Yes | Yes | Yes | Yes | 5.1 | No |
| 5-2 | Yes | Yes | Yes | Yes | 6.5 | No |
| 5-3 | Yes | Yes | Yes | Yes | 8.3 | No |

The molar ratios of tri-n-butylmethylammonium bis(trifluoromethanesulfonyl)imide to the —COOH groups in 77125 adhesive solution were 1.0, 1.6, and 2.0 in Comparative Examples 5-1 to 5-3, respectively. Ghosting marks were observed on PC and ABS sheets covered by the protective films of Comparative Examples 5-1 to 5-3.

It is clear that ghosting marks can be prevented by the addition of a weak alkaline metal imide or amine into a (meth)acrylate based pressure sensitive adhesive, wherein the molar ratio of the weak alkaline metal imide or amine to the —COOH groups contained in the (meth)acrylate based pressure sensitive adhesive is in a range of 1.0-5.0, more particularly in a range of 1.2-4.0, and most particularly in a range of 1.2-2.0.

Ghosting marks cannot be prevented by the addition of an acidic metal imide or amine into a (meth)acrylate based pressure sensitive adhesive.

1. An adhesive mixture comprising:
(meth)acrylate polymer, and
alkaline metal imide or amine,
wherein the alkaline metal imide or amine has a pKa of 11 to 20, and the molar ratio of the alkaline metal imide or amine to the —COOH groups contained in the (meth)acrylate polymer is in a range of 1.0-5.0.

2. The adhesive mixture according to claim 1, wherein the (meth)acrylate polymer is a homopolymer of a (meth)acrylate monomer, a copolymer of a (meth)acrylate monomer with one or more comonomers, or mixtures of one or more (meth)acrylate homopolymers and/or one or more (meth)acrylate copolymers.

3. The adhesive mixture according to claim 2, wherein the (meth)acrylate monomer is selected from alkyl (meth)acrylates having an alkyl group of 1-20 carbon atoms, aryl (meth)acrylates having an aryl group of 6-12 carbon atoms, and aralkyl (meth)acrylates having an aralkyl group of 6-12 carbon atoms.

4. The adhesive mixture according to claim 2, wherein the comonomer is selected from one or more vinyl monomers.

5. The adhesive mixture according to claim 1, wherein the (meth)acrylate polymer has a glass transition temperature of at least −60° C.

6. The adhesive mixture according to claim 1, wherein the alkaline metal imide or amine has a pKa of about 12 to about 18.

7. The adhesive mixture according to claim 1, wherein the alkaline metal imide or amine is selected from one or more of: lithium bis(trifluoromethanesulfonyl)imide, sodium bis(trifluoromethanesulfonyl)imide, potassium bis(trifluoromethanesulfonyl)imide, N,N′-bis(2,6-diisopropylphenyl)ethylenediamine, 6-benzylaminopurine, hexamethylenetetramine, N-ethyldiisopropylamine, 2-(diisopropylamino)ethylamine, di-n-butylamine, and dipentylamine.

8. The adhesive mixture according to claim 1, wherein the molar ratio of the alkaline metal imide or amine to the —COOH groups contained in the (meth)acrylate polymer is in a range of about 1.2 to about 4.0.

9. The adhesive mixture according to claim 1, wherein the molar ratio of the alkaline metal imide or amine to the —COOH groups contained in the (meth)acrylate polymer is in a range of about 1.2 to about 2.0.

10. The adhesive mixture according to claim 1, wherein the (meth)acrylate polymer is in the form of a solution.

11. An adhesive prepared from a reactant comprising the adhesive mixture according to claim 1.

12. A film, comprising:
a backing layer; and
an adhesive layer supported by the backing layer and prepared from an adhesive mixture according to claim 1.

13. The film according to claim 12, wherein the adhesive layer has a thickness of at least about 1 μm.

14. A method of preparing a film, comprising steps of:
(b) adding alkaline metal imide or amine into (meth)acrylate polymer to obtain a mixture, wherein the alkaline metal imide or amine has a pKa of 11 to 20, and the molar ratio of the alkaline metal imide or amine to the —COOH groups contained in the (meth)acrylate polymer is in a range of between about 1.0 to about 5.0;
(c) applying the mixture on at least part of a backing layer to form an adhesive layer; and
(d) drying the backing layer and the adhesive layer.

15. The method according to claim 14, further comprising a step of (a) determining the amount of —COOH groups in a (meth)acrylate polymer before the step (b);

16. The method according to claim 15, wherein the amount of —COOH groups in the (meth)acrylate polymer is determined by titration.

17. The method according to claim 14, wherein the alkaline metal imide or amine has a pKa of about 12 to about 18.

18. The method according to claim 14, wherein the molar ratio of the alkaline metal imide or amine to the —COOH groups contained in the (meth)acrylate polymer is in a range of about 1.2 to about 4.0.

19. The method according to claim 14, wherein the molar ratio of the alkaline metal imide or amine to the —COOH groups contained in the (meth)acrylate polymer is in a range of about 1.2 to about 2.0.

20. The method according to claim 14, wherein the mixture in step (b) is mixed for 10 to 120 min, at a temperature of 10 to 50° C.

21. (canceled)

22. (canceled)

23. (canceled)
